(19) United States
(12) Patent Application Publication
(10) Pub. No.: US 2026/0057388 A1
(43) Pub. Date: Feb. 26, 2026

(54) PAYMENT-ACCEPTING ENTITY CYBER THREAT DETECTION

(71) Applicant: Mastercard International Incorporated, Purchase, NY (US)

(72) Inventors: David Andrew Housman, Tampa, FL (US); Sharon Flategraff, Harrisburg, PA (US)

(21) Appl. No.: 19/300,124

(22) Filed: Aug. 14, 2025

Related U.S. Application Data
(60) Provisional application No. 63/685,466, filed on Aug. 21, 2024.

(51) Int. Cl. G06Q 20/40; H04L 9/40

(52) U.S. Cl. CPC G06Q 20/4016; H04L 63/1425

(57) ABSTRACT

In some aspects, the techniques described herein relate to a method, including: detecting, by a security system on a payment network, an anomaly associated with potential suspect activity in payment network activity associated with a particular merchant; retrieving, by the security system, a merchant identifier corresponding to the particular merchant, a merchant web address associated with the particular merchant, and time information of the anomaly; identifying a source for the potential suspect activity on the payment network by: obtaining IP network traffic data associated with the merchant web address and the time information of the anomaly; evaluating, by the security system, the IP network traffic data for patterns in the IP network traffic data that correspond to the anomaly; and determining, by the security system, a source IP address from the patterns in the IP network traffic data that correspond to the anomaly.

### BACKGROUND

Entities that participate in the payment process (e.g., merchants, service providers, etc.) can be targeted by bad actors who seek to exploit merchants to conduct payment card fraud via cyber-attacks. Examples of payment card fraud can include card testing, enumeration attacks, BIN (bank identification number) attacks, among others. In many cases, these acts of fraud can be characterized by higher-than-normal activity for a particular merchant.

### BRIEF SUMMARY

Payment-accepting entity cyber threat detection is provided that assists with the identification of bad actors responsible for fraudulent activity and/or malicious activity at a payment accepting entity.

In some aspects, the techniques described herein relate to a method, including: detecting, by a security system on a payment network, an anomaly associated with potential suspect activity in payment network activity associated with a particular merchant; retrieving, by the security system, a merchant identifier (ID) corresponding to the particular merchant, a merchant web address associated with the particular merchant, and time information of the anomaly; identifying a source for the potential suspect activity on the payment network by: obtaining IP network traffic data associated with the merchant web address and the time information of the anomaly; evaluating, by the security system, the IP network traffic data for patterns in the IP network traffic data that correspond to the anomaly; and determining, by the security system, a source IP address from the patterns in the IP network traffic data that correspond to the anomaly.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a typical process flow for an online transaction.

FIG. 2 illustrates an operating environment for merchant systems on the Internet in which the described security system can operate.

FIG. 3 illustrates an example process for identification of cyber actors targeting payment-accepting entities.

FIG. 4 illustrates components of a computing system that may be used in certain embodiments of a security system described herein.

### DETAILED DESCRIPTION

Payment-accepting entity cyber threat detection is provided that assists with the identification of bad actors responsible for fraudulent activity and/or malicious activity at a payment accepting entity.

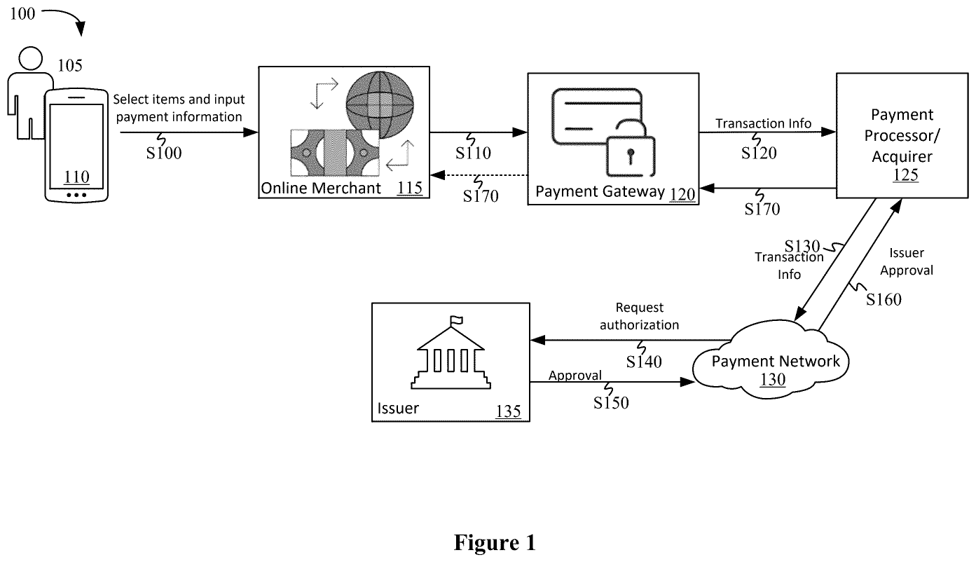

FIG. 1 illustrates a typical process flow for an online transaction. Referring to FIG. 1, as part of a typical online transaction flow 100, a user 105 accesses the online merchant 115, for example, via a graphical user interface (GUI) at a user device 110 (e.g., mobile device, computing device, etc.).

At step (S100), the user 105, via device 110, can select items to add items to the online shopping cart at the online merchant 115 and enter payment details at check-out. The payment details can include a bank identification number (BIN) (or “card number”), CVV, expiration date, cardholder name, and cardholder address. The online merchant 115 can utilize a payment gateway 120, which allows the online merchant 115 to accept payment, such as from a debit or credit card.

As shown at step (S110), the payment gateway 120 receives the payment information of the user 105 via the online merchant 115. Once the user 105 confirms to place the order, the payment gateway 120 can securely transmit the transaction information to a payment processor/acquirer 125, as shown in step (S120). The transaction information can include, but is not limited to, the payment card details, merchant identifier, and transaction total.

Then, at step (S130), the payment processor/acquirer 125 can send the transaction information (including the payment details) to a payment network 130 (e.g., card network) for verification and authorization (e.g., preauthorization) of the customer's 105 payment information.

At step (S140), the payment network 130 can send the request for verification and authorization (e.g., preauthorization) to the issuer 135. If the issuer 135 confirms that the customer has sufficient funds to pay for the online order, the issuer 135 can send a response to the payment network 130 to approve the transaction, as shown in step (S150).

Once the approval signal is received, the payment network 130 can forward the signal to the payment processor/acquirer 125, at step (S160). At step (S170) the payment processor/acquirer 125 can forward the signal to the online merchant 115 (e.g., via the payment gateway 120) to confirm the transaction has been accepted. Later on, settlement and clearing can occur. In clearing, the payment information can be double checked for accuracy. In settlement, the issuer 135 can transfer funds to the payment network 130; the payment network 130 can then transfer the funds to the payment processor/acquirer 125. Once the payment processor/acquirer 125 receives the funds, the funds can be made available to the online merchant 115.

A transaction, such as the one described in process flow 100, is an example of payment network activity. Payment network activity can include, but is not limited to, transactions occurring via the payment network 130 and associated information related to types of transactions, quantity of transactions, times of transactions.

Advantageously, on the payment network, there are systems in place to inhibit and/or detect fraudulent payment activity. For example, authentication and authorization processes with respect to cardholder identity, transaction amounts, and merchant identities are performed across a payment network and behaviors in this space can be analyzed for anomalies. Understanding the activity occurring on a network can be beneficial in identifying and stopping fraudulent activity and/or cyber-attacks in the payment processing space. The described systems and techniques use payment network behavior as a sensor node for detection of bad actors on a network or over the Internet.

There are many stages of a transaction as a transaction is carried out to completion on a payment network that involve ingress to and egress from different physical networks (e.g., the systems supporting the communications over Internet, private networks, cellular networks, wireless networks, etc.). By providing a method to map behavior in the payment process (along a payment network) to payment network activity occurring on the payment network, it is possible to better identify cyber threats and bad actors.

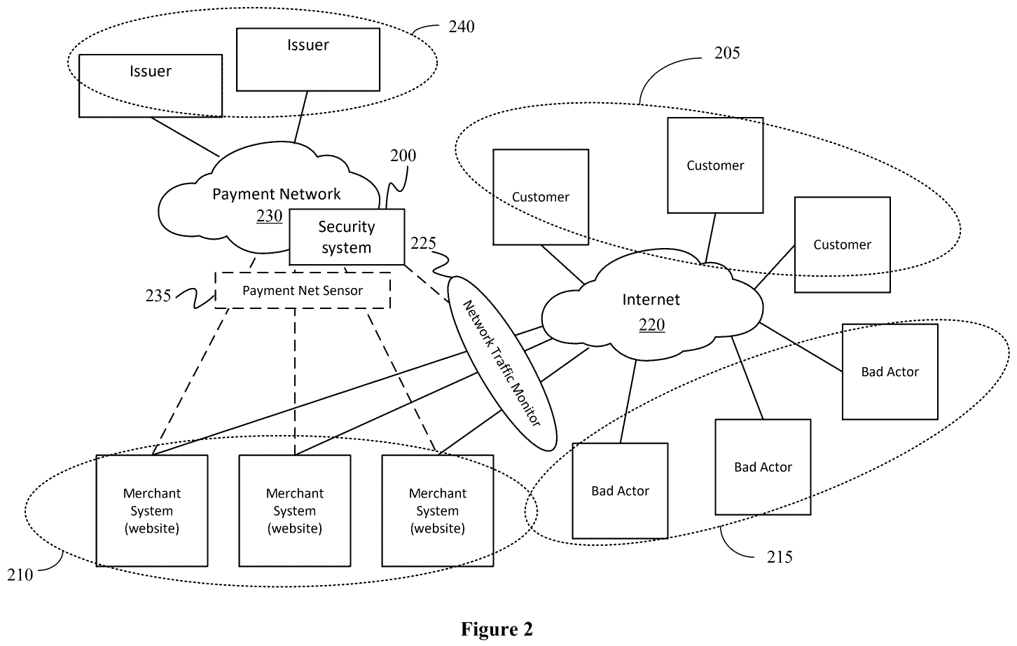

FIG. 2 illustrates an operating environment for merchant systems on the Internet in which the described security system can operate. Referring to FIG. 2, operating environment of security system 200 can include customers 205, merchant systems 210, bad actors 215, the Internet 220, Network traffic monitor 225, a payment network 230, a payment net sensor 235, and issuers 240.

The users 105 can be cardholders or persons authorized to use a payment account corresponding to the cardholder. The merchant systems 210 can be associated with merchants that are providers of goods or services in exchange for payment (e.g., online merchant 115 described with respect to FIG. 1). In some cases, the merchant systems 210 can be associated with any payment-accepting entity. A payment-accepting entity refers to any organization or individual that receives payment from a customer or client for goods or services.

The merchant systems 210 can be hosted by ecommerce platforms or web hosting platform with ecommerce capabilities. That is, in the context of the illustrated operating environment, a merchant system 210 provides a website through which purchases can be made by a customer 205 over the Internet 220. The ecommerce component of the merchant website enables access to the payment network 230 so that the conventional payment flow of customer payment to merchant point of interaction (e.g., merchant website accessed via customer device) to acquirer (not shown) to payment network 230 to issuer 240 (and back with a confirmation of payment authorization) can be accomplished by a customer making payment on a merchant website. The merchant associated with the merchant system can be any payment-accepting entity (e.g., retail merchant, service providers, FinTech, etc.). The payment network 230 is a credit card network that, in some cases, can be used to process and transfer funds from credit cards, debit cards, and other forms of payment (e.g., payment network 130 described with respect to FIG. 1).

Customers 205 can provide payment information to merchant systems 210 via the Internet 220. However, bad actors 215 can also engage in payment activities with merchant systems 210 or gain access to merchant systems 210 via the Internet 220. These bad actors 215 may be engaging in fraudulent payment activities (e.g., bank identification number (BIN) enumeration attacks, merchant impersonation, fraudulent primary account number (PAN) use, ransomware attack, etc.).

The payment network 230 can receive information from merchant systems 210 (e.g., payment processing information, payment network activity). Payment activity at merchant systems 210 can be monitored via systems, such as security system 200, on the payment network 230. For example, the payment net sensor 235 can provide information to the security system 200 at the payment network 230 in determining which merchant systems 210 may be being targeted by fraudulent activity. The payment net sensor 235 monitors transaction behavior and payment network activity across the payment network 230 for fraudulent activity and/or cyber-attacks. The security system 200 is not directly monitoring IP traffic. For example, payment net sensor 235 and security system 200 may identify a high-volume attack on a merchant due to high spikes in activity from a particular merchant. A high spike in activity from a particular merchant may be due to a bad actor attempting to identify whether a set of payment card credentials (that may have been stolen from the cardholder) are valid and can be used for unauthorized transactions (i.e., transactions not authorized by the cardholder). However, while detecting anomalous behavior at a particular merchant can be performed on the payment network (e.g., via payment net sensor 235), it is difficult to ascertain the identity of an actor behind the attack and/or the means for which the attack was facilitated. The security system 200 is not directly monitoring IP traffic.

As traffic flows across the Internet 220 (e.g., from customers 205 to merchant systems 210 and from bad actors 215 to merchant systems 210), IP traffic information can be collected (e.g., via network traffic monitor 225). For example, network traffic monitor 225 can monitor and collect information relating to IP traffic associated with the merchant systems 210. The network traffic monitor 225 can use the Cisco NetFlow network monitoring protocol and/or Linux Netfilter framework, among other IP traffic collector systems and/or protocols.

Advantageously, using the systems and methods described herein, the security system 200 can leverage both the information at the payment network 230 (e.g., as collected by the payment net sensor 235), and outside information (e.g., as collected by the network traffic monitor 225) to detect and assist with identifying a source of the fraudulent activity.

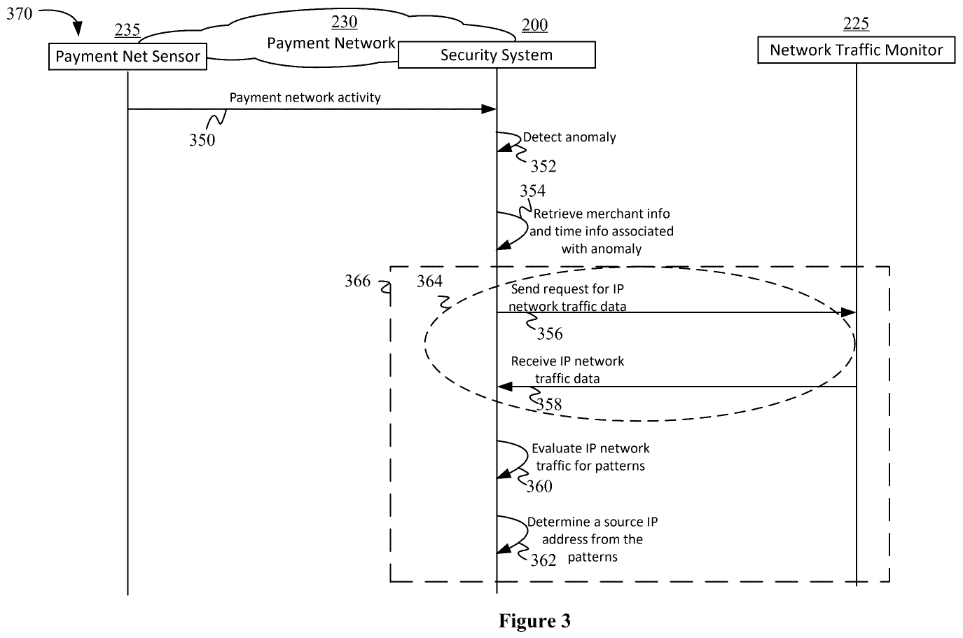

FIG. 3 illustrates an example process for identification of cyber actors targeting payment-accepting entities. Referring to FIG. 3, payment network activity 350 on the payment network from various merchant systems (e.g., online merchant 115 of FIG. 1 and/or merchant systems 210 of FIG. 2) is monitored by payment net sensor 235. Payment net sensor 235 can be part of, or in communication with, security system 200 at the payment network 230. The security system 200 can monitor payment network activity from a plurality of payment-accepting entities (e.g., a plurality of merchant systems).

The process 370 can begin when the security system 200 (directly or via payment net sensor 235) detects (352) an anomaly associated with potential suspect activity in the payment network activity 350. The anomaly in the payment network activity 350 may be activity indicative of fraudulent activity and/or a cyber-attack at a particular merchant system. For example, security system 200 may detect (352) a high-volume spike in activity at a website associated with a particular merchant system. Detection of anomalies associated with potential suspect activity on in the payment network activity by the security system 200 and/or payment net sensor 235 can be carried out using a variety of different techniques including, but not limited to, pattern detection and classification techniques using machine learning, neural networks, and other modalities.

Once an anomaly associated with potential suspect activity has been detected (352), security system 200 can retrieve (354) merchant information associated with the merchant system and time information of the anomaly. The merchant information can include a defined Internet presence (e.g., web address and/or server address) of the merchant system where the anomaly occurred. In some cases, merchant information can include a merchant identifier (merchant ID) corresponding to a particular merchant. The time information can include a time (or time frame) and date associated with the anomaly. The merchant information can be retrieved by the security system 200 from a data resource available on the payment network 230. The time information can be obtained from the payment network activity 350 information (and based on the anomaly detection).

Identifying that an anomaly has occurred at a merchant system enables additional measures to be carried out to protect the merchant or, at a minimum, halt approvals of certain payment activity. However, there are many disparate layers of information that facilitate modern transactions, and understanding the activity and corresponding data at various points of a transaction is difficult. Additionally, there are limitations and feasibility constraints in gaining access to this highly relevant data en masse.

Advantageously, in response to detecting (352) the anomaly and retrieving (354) the merchant information and time information of the anomaly, the security system 200 can identify (366) a source for the potential suspect activity. The security system 200 can identify (366) a source for potential suspect activity by obtaining (364) IP network traffic data associated with merchant web address and the time information of the anomaly, evaluating (360) the IP network traffic data for patterns in the IP network traffic data that correspond to the anomaly, and determining (362) a source IP address from the patterns in the IP network traffic data that correspond to the anomaly. Certain operations can include the use of machine learning or other artificial intelligence (AI).

For example, the system on the payment network 130 can obtain (364) IP network traffic data by sending (356) a request for IP network traffic data to the network traffic monitor 225 and receiving (358) IP network traffic data from the network traffic monitor 225. The request for IP traffic data can include the merchant information and the time information. The request for IP traffic data is requesting IP network traffic data that occurred at the web address and/or server address of the merchant system at the time and date of the anomaly. The IP network traffic data can include IP addresses active at the web address and/or server address of the merchant system at the time and date of the anomaly.

The security system 200 can then evaluate (360) the IP network traffic data for patterns in the IP network traffic data and identify any patterns that appear associated with the anomaly. When the security system 200 evaluates the IP network traffic data, the security system 100 may take into account other factors, including the merchant information, the time information, historical information (e.g., previous attacks/evaluations), and previously discovered patterns.

By evaluating (360) the IP network traffic data for patterns that appear associated with the anomaly, the security system 200 can identify more information about the source of the attack. For example, the security system 200 may identify patterns in traffic that indicate probable attackers IP addresses, develop signatures of a particular type of attack, identify other probable victims (e.g., other merchant systems 210 as described with respect to FIG. 2), and/or identify probable bad actor infrastructure used to conduct fraud/cyber-attack or additional infrastructure (e.g., active or parked), among other examples.

Upon evaluating (360) the IP network traffic data, the security system 200 can determine (362) a source IP address from the patterns in the IP network traffic data that correspond to the anomaly.

In some cases, upon determining (362) the source IP address from the patterns in the IP network traffic data that correspond to the anomaly, the security system 200 can provide the source IP address to a system at the payment network 230 for further evaluation. In some cases, the payment network 230 can use the source IP address to identify probable attack victims (e.g., probable victim IP addresses, subdomains, and/or URLs). For example, the probable attack victims can be merchant systems in addition to the particular merchant (e.g., from merchant systems 210 described with respect to FIG. 2). In some cases, the payment network 230 can use the source IP address to identify a probable threat actor infrastructure used to cause the anomaly associated with potential suspect activity in payment network activity.

An illustrative scenario is provided as follows and with reference to FIG. 3. Payment network activity associated with merchant A includes a large number of transactions above a typical amount of transactions for merchant A occurring between the time period of 12:00 AM-1:00 AM. This activity may be indicative of a bank identification number (BIN) enumeration attack due to the large number of transactions in a small time period. A BIN enumeration attack can occur when a bad actor systematically submits card-not present (CNP) authorization attempts, concentrating on a single BIN or multiple BINs, and while iterating through various combinations of payment credentials (e.g., primary account number (PAN), expiration date, card verification value 2 (CVV2), and postal code. Issuers decline the authorization attempts until the right combination of payment values returns an approval response. An approved authorization response (and often a subsequent sale) is an indicator to the threat actor that they have obtained a combination of valid payment values. As such, the unexpectedly high number of transactions and/or issuer declines can signal a potential BIN enumeration attack.

The payment net sensor 235 and/or security system 200 can detect (352) an anomaly associated with potential suspect activity in the payment network activity associated with Merchant A based on the total number of transactions that occurred during this time period is unusually high. In response to detecting (352) the anomaly, security system 200 can retrieve (354) merchant information associated with the Merchant A (e.g., merchant ID associated with Merchant A and Merchant A's web address) and time information of the anomaly (e.g., between 12:00 AM-1:00 AM on Jan. 1, 2024).

The security system 200 uses the merchant information associated with Merchant A and the time information of the anomaly to obtain (364) IP network traffic data associated with Merchant A's web address at the time of the anomaly. To obtain (364) the IP network traffic data, the security system 200 can send (356) a request for IP network traffic data to a network traffic monitor 225. The request for IP network traffic data can include Merchant A's web address and the time information.

The security system 200 receives (358) IP network traffic data for Merchant A's web address at the time indicated by the time information (e.g., between 12:00 AM-1:00 AM on Jan. 1, 2024). Using the IP network traffic data, the security system 200 can identify (366) a source for the potential suspect activity. First, the security system 200 can evaluate (360) the IP network traffic data for Merchant A's web address for patterns matching or otherwise satisfying conditions of the anomaly detected in the payment processing data. In this case, because the security system 200 has identified that the anomaly is potentially a BIN enumeration attack (e.g., based on the high volume of transactions), the security system 200 can evaluate the IP network traffic for patterns aligning with BIN enumeration attack patterns. For example, if, a high number of accesses to the merchant IP address come from a particular source IP address or cluster of source IP addresses, the security system 200 may determine (352) that that source IP address from the identified pattern corresponds to the anomaly. In some cases, the source IP address may be a single IP address. In some cases, there can be a plurality of IP addresses that appear to be the source.

Advantageously, the useful information gleaned from detecting anomalies from payment network activity data and evaluating merchant-specific/times-specific IP network traffic for patterns (using the contextual information available to the payment network 230) can be used to generate preventative measures, warn merchants, and identify bad actors. Indeed, by using sensors that detect anomalous traffic and attacks on a payments network (e.g., payment net sensor 235), it is possible to identify affected merchants in the payment ecosystem, obtain Internet presence information of those merchants (e.g., website IP addresses), and then augment the event with corresponding IP network traffic data that reveals who is behind a given event, at a specific time, affecting a specific entity. The result of the process can then be used to enhance decision making in both the payments networks and computer networks. The above-described techniques enable the payment network to provide additional security without direct access to a merchant's technology infrastructure.

The operations of the process described with respect to FIG. 3 can be performed for a plurality of merchant systems associated with a plurality of different merchants. In some cases, the security system 200 can detect that a same or similar anomaly has occurred at a different merchant system (or a plurality of different merchant systems). Detecting the same or similar anomaly across multiple merchants may be indicative that these merchant systems are victims of a common bad actor.

Advantageously, the security system 200 can leverage the collection of IP network traffic data associated with different merchants to evaluate whether there is a common IP address across the IP network traffic data associated with the different merchants experiencing the anomaly. In some cases, if a common IP address is identified, the security system 200 can determine that the common IP address is a source IP address corresponding to the anomaly.

For example, in some cases, the security system 200 can detect (352) the same or similar anomaly in payment network activity associated with a different merchant. In this case, evaluating (360) the IP network traffic data for patterns can include both evaluating the IP network traffic data associated with the first merchant and evaluating the IP network traffic data associated with the different merchant to identify a common source IP address. The common source IP address can be an IP address found in both the IP network traffic associated with the first merchant and the IP network traffic data associated with the different merchant. In this case, determining (362) a source IP address from the patterns in the IP network traffic data correspond to the anomaly can include determining (362) that the common source IP address corresponds to the anomaly.

In some cases, the security system 200 can evaluate IP network traffic data across a plurality of merchants with detected anomalies that are not the same or similar to identify if there is a common IP address across the multiple different merchants.

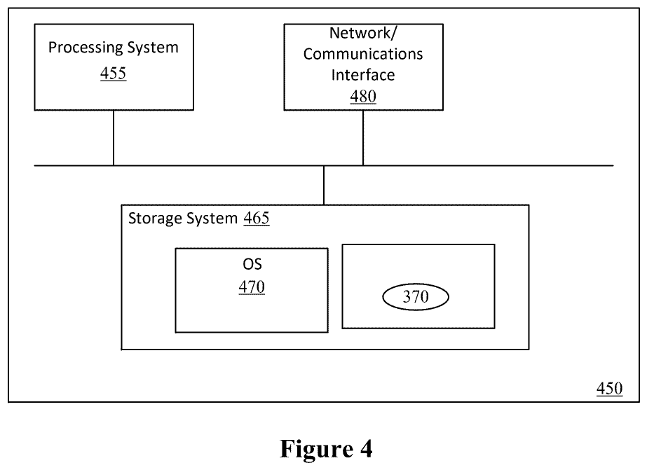

FIG. 4 illustrates components of a computing system that may be used in certain embodiments of a security system described herein. Referring to FIG. 4, system 450 can include one or more blade server devices, personal computers, routers, hubs, switches, bridges, firewall devices, intrusion detection devices, mainframe computers, network-attached storage devices, and other types of computing devices. The system hardware can be configured according to any suitable computer architecture.

The system 450 can include a processing system 455, which may include one or more processors and/or other circuitry that retrieves and executes software from the storage system 465.

The processing system 455 may be implemented within a single processing device but may also be distributed across multiple processing devices or sub-systems that cooperate in executing program instructions.

The storage system 465 can store an operating system 470 and software for executing various implementations of process 370, described herein.

Storage system 465 may include volatile and nonvolatile memories, removable and non-removable media implemented in any method or technology for storage of information, such as computer readable instructions, data structures, program modules, or other data. Examples of storage media of storage system 465 include random access memory, read only memory, magnetic disks, optical disks, CDs, DVDs, flash memory, magnetic cassettes, magnetic tape, magnetic disk storage or other magnetic storage devices, or any other suitable storage media. In no case is the storage medium a transitory propagated signal.

Storage system 465 may be implemented as a single storage device but may also be implemented across multiple storage devices or sub-systems co-located or distributed relative to each other. In some cases, storage system 465 can include or be implemented as cloud storage. Storage system 465 may include additional elements, such as a controller, capable of communicating with processing system 455. The storage system 465 may also include storage devices and/or sub-systems on which data is stored. System 450 may access one or more storage resources in order to access information to carry out any of the processes (e.g., process 370) indicated by software.

Software at the storage system 465 may be implemented in program instructions and among other functions may, when executed by system 450 in general or processing system 455 in particular, direct system 450 or the one or more processors of processing system 455 to operate as described herein (e.g., process 370).

Network interface 480 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS 470, which informs applications of communications events when necessary.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method, comprising:
detecting, by a security system on a payment network, an anomaly associated with potential suspect activity in payment network activity associated with a particular merchant;
retrieving, by the security system, a merchant identifier (ID) corresponding to the particular merchant, a merchant web address associated with the particular merchant, and time information of the anomaly;
identifying a source for the potential suspect activity on the payment network by:
obtaining IP network traffic data associated with the merchant web address and the time information of the anomaly;
evaluating, by the security system, the IP network traffic data for patterns in the IP network traffic data that correspond to the anomaly; and
determining, by the security system, a source IP address from the patterns in the IP network traffic data that correspond to the anomaly.

2. The method of claim 1, wherein the anomaly corresponds to an enumeration attack.

3. The method of claim 1, wherein the time information comprises a date and a time associated with the anomaly.

4. The method of claim 1, wherein obtaining the IP network traffic data associated with the merchant web address and the time information of the anomaly comprises:
sending a request to an IP traffic collection system, wherein the request includes the merchant web address and the time information of the anomaly; and
receiving a response from the IP traffic collection system, the response comprising the IP network traffic data.

5. The method of claim 1, further comprising:
detecting, by the security system, the anomaly associated with potential suspect activity in the payment network activity associated with a different merchant;
retrieving, by the security system, a second merchant ID corresponding to the different merchant, a second merchant web address associated with the different merchant, and corresponding time information of the anomaly;
obtaining corresponding IP network traffic data associated with the second merchant web address and the corresponding time information of the anomaly;
wherein identifying the source for the potential suspect activity on the payment network further comprises:
evaluating, by the security system, the corresponding IP network traffic data for patterns in the corresponding IP network traffic data that correspond to the anomaly;
wherein evaluating the IP network traffic data and evaluating the corresponding IP network traffic data comprises identifying a common source IP address; and
determining, by the security system, a corresponding source IP address from the patterns in the corresponding IP network traffic data that correspond to the anomaly, wherein the corresponding source IP address comprises the common source IP address.

6. The method of claim 1, further comprising:
monitoring, by the security system, payment network activity from a plurality of payment-accepting entities comprising a plurality of merchants.

7. The method of claim 1, further comprising:
providing the source IP address to a system on the payment network to identify probable attack victims.

8. A system, comprising:
a processing system;
one or more storage media; and
instructions stored on the one or more storage media that, when executed by the processing system, direct the system to:
detect, by a security system on a payment network, an anomaly associated with potential suspect activity in payment network activity associated with a particular merchant;
retrieve, by the security system, a merchant identifier (ID) corresponding to the particular merchant, a merchant web address associated with the particular merchant, and time information of the anomaly;
identify a source for the potential suspect activity, wherein the instructions to identify the source for the potential suspect activity direct the system to:
obtain IP network traffic data associated with the merchant web address and the time information of the anomaly;
evaluate, by the security system, the IP network traffic data for patterns in the IP network traffic data that correspond to the anomaly; and
determine, by the security system, a source IP address from the patterns in the IP network traffic data that correspond to the anomaly.

9. The system of claim 8, wherein the anomaly corresponds to an enumeration attack.

10. The system of claim 8, wherein the time information comprises a date and a time associated with the anomaly.

11. The system of claim 8, wherein the instructions to obtain the IP network traffic data associated with the merchant web address and the time information of the anomaly further direct the system to:
send a request to an IP traffic collection system, wherein the request includes the merchant web address and the time information of the anomaly; and
receive a response from the IP traffic collection system, the response comprising the IP network traffic data.

12. The system of claim 8, wherein the instructions further direct the system to:
detect, by the security system, the anomaly associated with the potential suspect activity in payment network activity associated with a different merchant;
retrieve, by the security system, a second merchant ID corresponding to the different merchant, a second merchant web address associated with the different merchant, and corresponding time information of the anomaly;
obtain corresponding IP network traffic data associated with the second merchant web address and the corresponding time information of the anomaly; and
wherein the instructions to identify the source for the potential suspect activity further directs the system to:
evaluate, by the security system, the corresponding IP network traffic data for patterns in the corresponding IP network traffic data that correspond to the anomaly;
wherein the instructions to evaluate the IP network traffic data and to evaluate the corresponding IP network traffic data further direct the system to identify a common source IP address; and
determine, by the security system, a corresponding source IP address from the patterns in the corresponding IP network traffic data that correspond to the anomaly, wherein the corresponding source IP address comprises the common source IP address.

13. The system of claim 8, wherein the instructions further direct the system to:
monitor, by the security system, payment network activity from a plurality of payment-accepting entities comprising a plurality of merchants.

14. The system of claim 8, wherein the instructions further direct the system to:
provide the source IP address to a system on the payment network to identify probable attack victims.

15. A computer readable storage medium having instructions of payment network system stored thereon that when executed by a computing system, direct the computing system to at least:
detect, by a security system on a payment network, an anomaly associated with potential suspect activity in payment network activity associated with a particular merchant;
retrieve, by the security system, a merchant identifier (ID) corresponding to the particular merchant, a merchant web address associated with the particular merchant, and time information of the anomaly;
identify a source for the potential suspect activity on the payment network, wherein the instructions to identify the source for the potential suspect activity on the payment network direct the computing system to:
obtain IP network traffic data associated with the merchant web address and the time information of the anomaly;
evaluate, by the security system, the IP network traffic data for patterns in the IP network traffic data that correspond to the anomaly; and
determine, by the security system, a source IP address from the patterns in the IP network traffic data that correspond to the anomaly.

16. The computer readable storage medium of claim 15, wherein the anomaly corresponds to an enumeration attack.

17. The computer readable storage medium of claim 15, wherein the time information comprises a date and a time associated with the anomaly.

18. The computer readable storage medium of claim 15, wherein the instructions to obtain the IP network traffic data associated with the merchant web address and the time information of the anomaly further directs the computing system to:
send a request to an IP traffic collection system, wherein the request includes the merchant web address and the time information of the anomaly; and
receive a response from the IP traffic collection system, the response comprising the IP network traffic data.

19. The computer readable storage medium of claim 15, wherein the instructions further direct the computing system to:
detect, by the security system, the anomaly associated with the potential suspect activity in payment network activity associated with a different merchant;
retrieve, by the security system, a second merchant ID corresponding to the different merchant, a second merchant web address associated with the different merchant, and corresponding time information of the anomaly;
obtain corresponding IP network traffic data associated with the second merchant web address and the corresponding time information of the anomaly; and
wherein the instructions to identify the source for the potential suspect activity on the payment network further directs the computing system to:
evaluate, by the security system, the corresponding IP network traffic data for patterns in the corresponding IP network traffic data that correspond to the anomaly;
wherein the instructions to evaluate the IP network traffic data and to evaluate the corresponding IP network traffic data further direct the computing system to identify a common source IP address; and
determine, by the security system, a corresponding source IP address from the patterns in the corresponding IP network traffic data that correspond to the anomaly, wherein the corresponding source IP address comprises the common source IP address.

20. The computer readable storage medium of claim 15, wherein the instructions further direct the computing system to:
provide the source IP address to a system on the payment network to identify probable attack victims.
